(19) United States
(12) Patent Application Publication
(10) Pub. No.: US 2004/0085565 A1
(43) Pub. Date: May 6, 2004

(54) Measuring consumable sufficiency before printing

(76) Inventors: Kevin Owen, Meridian, ID (US); Jeetendra Kumar, Boise, ID (US); Travis Moats, Nampa, ID (US); Roman Wachter, Boise, ID (US); Mark W. Clark, Meridian, ID (US)

Correspondence Address: HEWLETT-PACKARD COMPANY, Intellectual Property Administration, P. O. Box 272400, Fort Collins, CO, 80527-2400, US

(21) Appl. No.: 10/283,673

(22) Filed: Oct. 30, 2002

(51) Int. Cl. G06F 3/12; G06F 11/30; G06F 19/00

(52) U.S. Cl. 358/1.14; 399/24; 700/106; 358/1.15; 710/15

(57) ABSTRACT

A printing device has a replaceable component. The printing device uses the replaceable component when printing. The replaceable component at the printing device is measured to determine its availability. A requirement is calculated as to what is needed from the replaceable component in order to print a print job at the printing device. The print job is transmitted to the printing device when the availability is not less than the requirement but not when the availability is less than the requirement.

### FIELD OF THE INVENTION

The present invention relates to printing that uses a consumable. More particularly, the invention relates to printing after the availability of the consumable has been measured and determined to be sufficient for the printing.

### BACKGROUND OF THE INVENTION

Most types of printing devices are equipped with items that are used up and/or have a life cycle during printing operations. These items can include one or more printing supplies, a printing media available to be printed on during the printing, a printing substance available for application to the printing media during the printing such as toner or ink available for application to paper or to a synthetic substrate during the printing, staples for stapling the printing media during the printing process, a storage volume that is available to store paper that has been printed on by the printing device, and the like. These items are referred to herein as replaceable components. When a replaceable component is exhausted or at the end of its life cycle, the replaceable component must be replaced for the printing device to continue to function properly. For example, a replaceable component can be refilled when it is exhausted, or a container that contains an exhausted replaceable component can be removed and a full replaceable component installed in a printer to provide a refilled printing supply for the printing process.

Replaceable components can be manufactured with memory which can be placed on the component itself or within a label affixed to the component. This memory is typically used to store printer-related data that the printer reads to determine various printing parameters. For example, the memory may store the model number of the component so that the printer may recognize the cartridge as valid or invalid for use with that printer.

As documents are printed, the replaceable component is gradually depleted. The printer communicates with the memory of the replaceable component to estimate when a state of exhaustion has been reached. Once the replaceable component has been estimated to have been exhausted, the printer will stop printing. The printer is also configured to resume printing when the replaceable component is replaced. The cessation from printing can occur at any point in a print job that a user has requested and has been waiting for. The user cannot determine, prior to scheduling the requested print job, whether or not the replaceable components needed for the requested print job are sufficient to complete the requested print job. The user's intentions can become frustrated when the user schedules a print job that is only partially printed by the printer due to an unforeseen lack of one or more replaceable components. Consequently, there is a need for improved methods, computer-readable medium, and host computing systems that provide a user with advance notice as to the availability of a replaceable component for a print job.

### SUMMARY OF THE INVENTION

The above-stated needs and/or others are met, for example, by use of a printing device having a replaceable component that is used when printing. A designation is received for a print job to be printed at the printing device. A requirement is calculated for the replaceable component to print the designated print job at the printing device. The replaceable component at the printing device is measured to determine an availability of the replaceable component. The designated print job is transmitted for printing at the printing device when the availability is not less than the requirement for the replaceable component. A diagnostic is output without transmitting the designated print job for printing at the printing device when the availability is less than the requirement.

### DESCRIPTION OF THE DRAWINGS

The present invention is illustrated by way of example and not limitation in the figures of the accompanying drawings. The same numbers are used throughout the figures to reference like components and/or features.

FIG. 1 illustrates an implementation of a network environment in which multiple servers, one or more workstations, and printers are coupled to one another via an interconnected network.

FIG. 2 is a diagrammatic illustration of an implementation of a laser printer.

FIG. 3 is a diagrammatic illustration of an implementation of a laser printer toner cartridge in a laser printer.

FIG. 4 is a block diagram of an implementation of a printing system.

FIG. 5 is a block diagram of a computer in an implementation of a printing system.

FIG. 6 is a flow diagram of an implementation of a dynamic messaging process utilizing an algorithm for measurement of a replaceable component to determine availability of same for a print job.

FIG. 7 is a diagram of an implementation of a messaging process for user communication.

FIG. 8 is an implementation of a table of entries, each listing a replaceable component, a measurement tool, and a corresponding End-of-Life Calculation.

### DETAILED DESCRIPTION

Methods, computer-readable media, and host computer systems such as personal computer (PC), according to various implementations, relate to a client device or document processing device such as personal computer (PC) that executes a document processing application, such as a word processor application, that creates and/or stores a document that is to be output at a printing device. The document processing application has one or more printer driver applications that create print data from the document that has been stored and/or created by the document processing application. In order to print out the document, the document processing application receives a request for a printing function to obtain a print out on a printing device specified in the requested printing function. One of more printer driver applications then calculate the number of pages that are to be printed in a print job in which the created print data will be printed. An aspect of the one or more printer driver applications coordinates measurements of one or more replaceable components that are needed to print the print job. These measurements are used to determine the availability of each of the one or more replaceable components at the specified printing device. These measurements can be made using conventional measurement tools, such as one or more sensors that communicate with the printing device and/or its components to determine the amount, level, quality condition, and/or quantity of the various replaceable components. These measurements can be used by aspects of the one or more printer driver applications to compare the measured availability of each replaceable component to the requirements of the requested print job.

Once the availability of each replaceable component has been ascertained by measurement, the printing function sends print data to the requested printing device and the printing of a corresponding print job begins. If it is determined that one or more of the replaceable components needed to print a print job is lacking, a diagnostic identifying the deficient one or more replaceable components will be output along with the number of pages that the printing device will be able to print out giving the measured availability of the deficient one or more replaceable components. The user is prompted to input the number of pages or to simply print all of the pages in the pending job. Given the identified deficiency of the one or more replaceable components, the user may input a number of pages that is less than or equal to the identified number of pages that the printing device can be print before exhausting the identified one or more replaceable components that have been measured and found to be insufficient for printing the entire print job. Based upon the user's input in response to the prompt, the printing of the print job will be performed by the printing device for the user-specified portion of the print job.

The printing device can include a memory for storing replaceable component usage data used in measuring the availability of the corresponding replaceable component and then evaluating how much of the replaceable component can be used before arriving at an end-of-life condition for the replaceable component. The replaceable component usage data in the memory is updated during the printing. The memory can, but need not be, integral with the replaceable component. Examples of integral memory are a radio frequency identification (RFID) memory and a direct contact identification memory.

The end-of-life condition of a replaceable component can be an insufficiency of printing supplies in the replaceable component. By way of example, and not by way of limitation, this insufficiency can be the printing media (e.g. paper) available to be printed on during the printing, the printing substance (e.g. printing ink) available for application to the printing media during the printing, the toner available for application to the printing media during the printing, staples that are available for stapling the printing media during the printing, storage available for storing the printing media after it has been printed by the printing device, etc.

In various implementations, the printing device and/or the replaceable component can have one or more sensors. Each sensor can sense an aspect of the replaceable component to measure its availability at the printing device. When a printing device is printing, the printing device will be stopped in response to an end-of-life condition of the replaceable component that is signaled by a corresponding measurement of the one or more sensors. Moreover, the measurements made by the one of more sensors for any replaceable components are used in comparisons with the requirements of a print job so as to compute and identify, in advance of printing the print job, any insufficiencies in one or more of the replaceable components that are needed to print the print job. Additionally, historical data as to the past use of a replaceable component can be use in combination with the one or more sensors to determine availability of replaceable components for printing a print job prior to scheduling the print job to be printed.

The printing device communicates with a host computing system that has an input mechanism to receive a demand for a printing operation. The input mechanism can be a keyboard, a computer mouse, a button, a toggle switch, or other known input systems that can be activated by a user. The host computing system has an output mechanism associated with the printing device upon which a diagnostic can be displayed that identifies one or more replaceable components lacking in availability to print a requested print job. The output mechanism can be a display screen in communication with the host computing system that is in communication with the printing device. The diagnostic can also be printed on a hardcopy printout by the printing device or another printing device.

Memory in the printing device, in the replaceable component, and/or in the host computing system can be used to store measurements made with respect to the availability of replaceable components and to store replaceable component usage data. These data can be stored in a memory device periodically during the printing operations and/or at predetermined intervals during the printing operations, where the data is initialized after the replaceable component is installed in the printing device.

The stored data can be used to calculate when one or more replaceable components are at an end-of-life condition. Real time measurements of replaceable components can be compared to calculated print job requirements to determine when one or more required replaceable components will be at an end-of-life condition prior to the completion of a requested print job. This determination can be output and reviewed by a user prior to starting the printing of the print job at the printing device.

By way of example, and not by way of limitation, a laser printer can have one or more toner cartridges that are installable in and removable from the laser printer. The toner cartridges can have one or more sensors that are configured to sense a quantity of toner (e.g. a weight measurement in grams) that has been used from the initial quantities in the one or more toner cartridges and/or the quantity of toner that remains in the one or more toner cartridges. Readings from the one or more sensors can be acquired by a reader/writer located in the laser printer that monitors the one or more sensors as well as any replaceable component usage data for the one or more toner cartridges. An aspect of one or more printer driver applications performs a rasterization process for one or more color planes of a document that a user has requested to have printed. The results of the rasterization process are stored in a memory device for future use and the results are also used to calculate the number of grams of toner that are needed to print the requested document. This calculation is compared to the measurements taken by the one or more sensors to arrive at a determination as to the availability of toner in the one or more toner cartridges to print the requested document. A deficiency of availability can be output in a diagnostic for review by the requesting user.

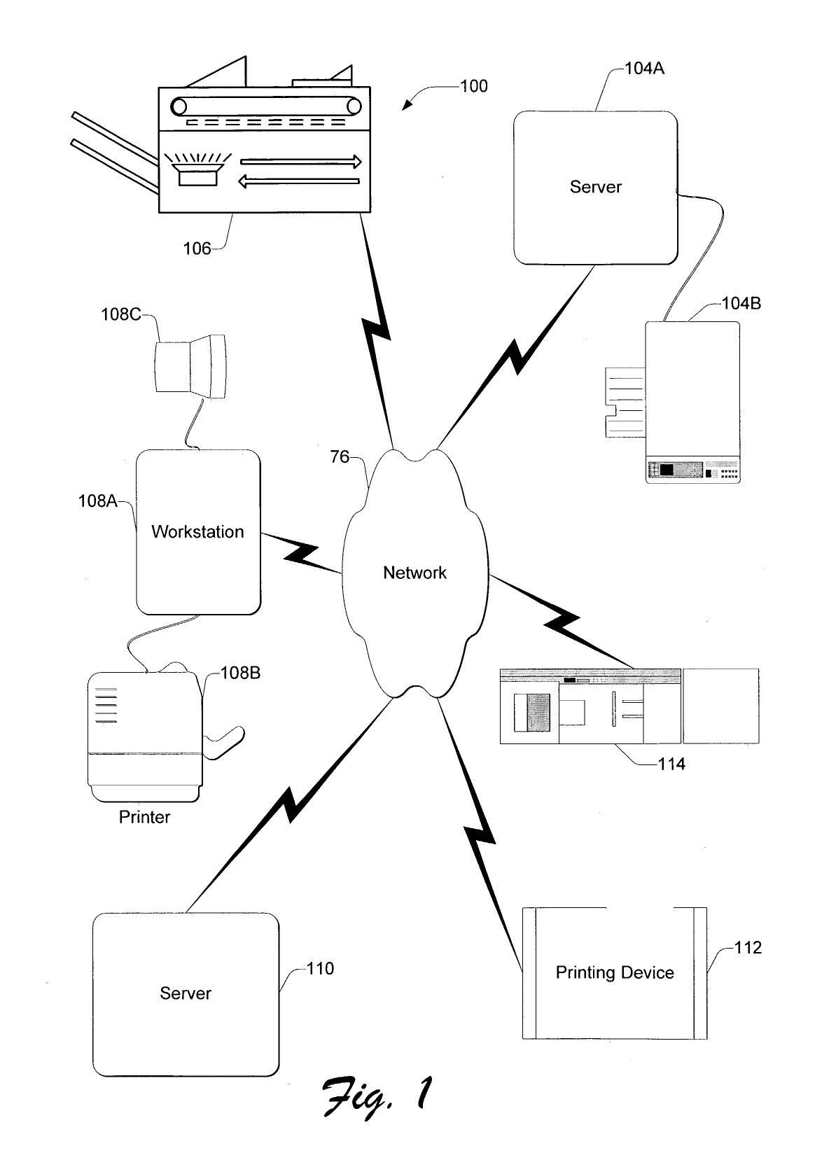

FIG. 1 illustrates a network environment 100 in which a plurality of network resources are communication via an interconnected network 76. As such, multiple servers 104A, 110, a workstation 108A, and printing devices 104B, 106, 108B, 112, 114 are coupled to one another via interconnected network 76. Interconnected network 76 couples together servers 104A and 110, computer workstation 108A, printing devices 104B, 106, 108B, 112, and 114, and a computer monitor 108C. Printing devices 104B, 108B and computer monitor 108C are coupled to interconnected network 76 through their respective local connections to server 104A and workstation 108A. Interconnected network 76 can be any type of network, such as a local area network (LAN) or a wide area network (WAN), using any type of network topology and any network communication protocol. In a particular embodiment, interconnected network 76 can be the Internet. Although only a few devices are shown coupled to interconnected network 76, a typical network may include tens or hundreds of devices coupled to one another. Furthermore, interconnected network 76 may be coupled to one or more other networks, thereby providing coupling between numerous devices. A user can schedule a print job at any server 104A, 110 or workstation 108A to be printed at any printing device 104B, 106, 108B, 112, 114.

Servers 104A and 110 may be file servers, e-mail servers, database servers, print servers, or any other type of network server. Workstation 108A can be any type of computing device, such as a mobile computing device, including a personal computer, a laptop computer, and a personal digital assistant (PDA). Although not shown in FIG. 1, one or more workstations and/or servers may contain a print rendering engine capable of converting raw print job data into a particular format (e.g., language) understood by certain types of printers.

Particular implementations illustrate an ink jet printer 104B and laser printers 106, 108B. Alternate implementations, however, are implemented with other printers such as with printing device 112 that is illustrated as being in communication with interconnected network 76 independent of a server or workstation. Printing device 112 is intended to represent a printer to which output can be directed from a computing device, including but not limited to, laser printers, ink-jet printers, bubble-jet printers, copiers, fax machines, and the like. Additionally, printing device 112 can be any type of device that can output a print job by hardcopy such as on paper, and any other type of printer including those referred to above. A digital press or network copier 114 is seen in FIG. 1 as a printing device to which output can be directed according to at least one implementation.

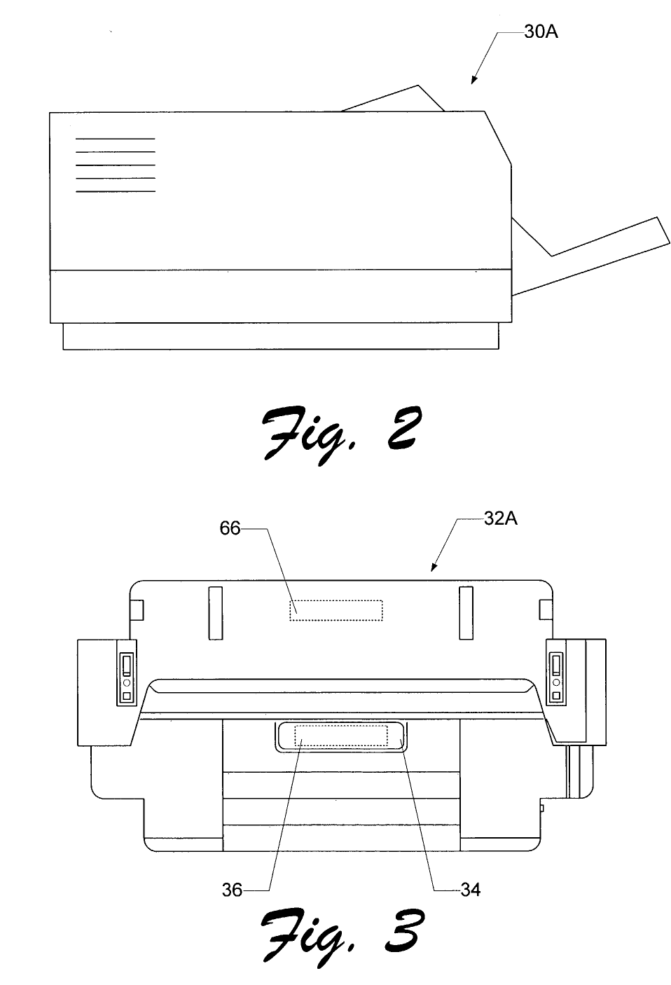

FIG. 2 is a diagrammatic illustration of a laser printer 30A implementation. FIG. 3 shows a toner cartridge 32A that is installable in the laser printer 30A. The toner cartridge 32A has a label 34 that contains information identifying the toner cartridge 32A to a user. The label 34 typically recites the name of the manufacturer, the model number of the cartridge, etc. Although various implementations are shown and described herein with respect to a printer toner cartridge for a laser printer, it is noted that other implementations can be a replaceable component (toner cartridge, ink cartridge, fuser, drum, etc.) installable in a printing device (printer, copier, fax machine, etc.).

A memory tag 36 is located underneath the label 34 on the toner cartridge 32A, although the memory tag 36 may be placed on or in the toner cartridge 32A at any location which may be practical for the purposes described herein. The memory tag 36, which can be conventional semiconductor memory, can communicate with laser printer 30A by a direct electrical connection thereto, and would be, as such, a direct connection memory tag. Alternatively, memory tag 36 can be an RFID memory tag. RFID memory tags, sensor communications, and applications therefore are well known in the art. One or more sensors 66 can be in and/or on the toner cartridge 32A so that they can be used to sense and/or measure a quantity of toner that is available of in the toner cartridge 32A.

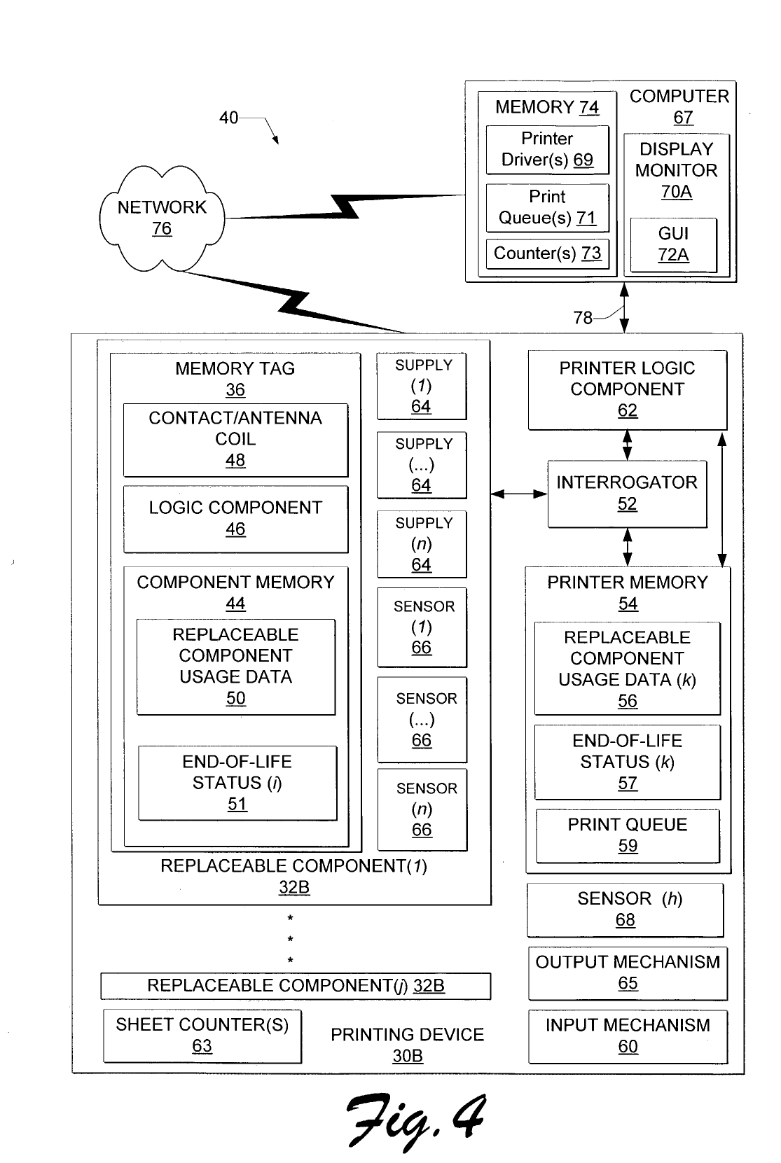

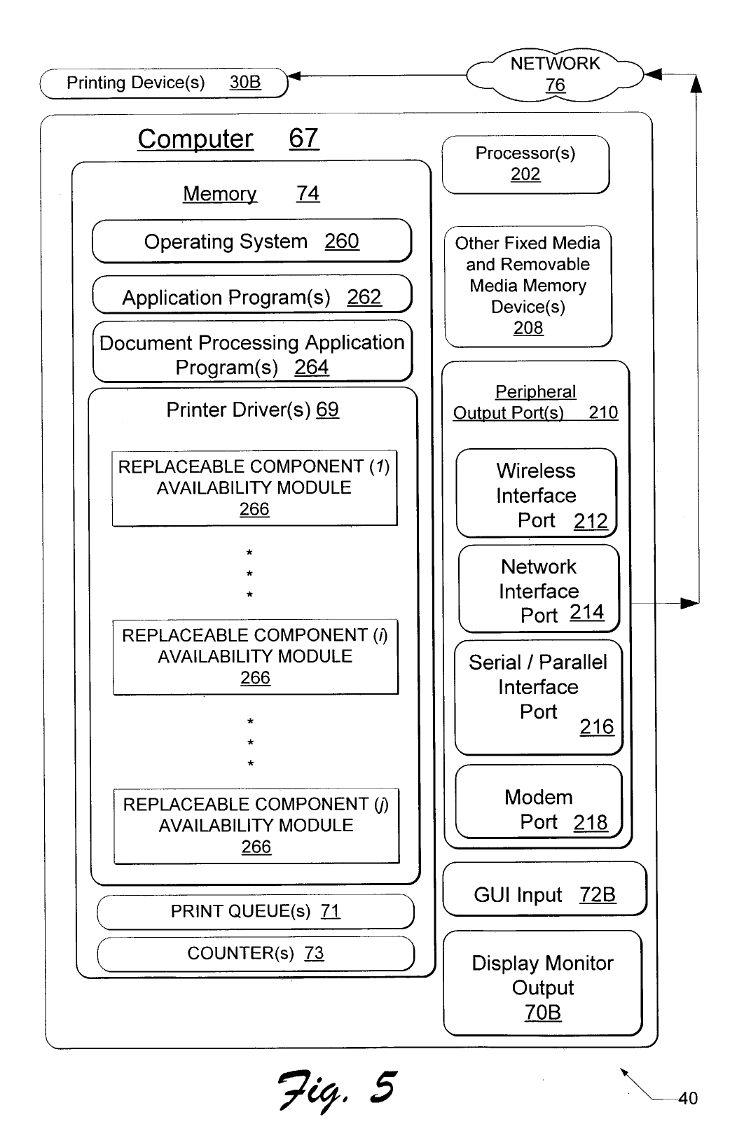

FIG. 4 is a block diagram of a printing system 40 that includes a printing device 30B. Printing device 30B has replaceable component (l) 32B through replaceable component (j) 32B. Each replaceable component 32B is installed in printing device 30B and may be removed and replaced by a like replaceable component (not shown). Each replaceable component 32B can include a memory tag 36 and one or more of supply (l) 64 through supply (N) 64. When printing device 30B prints, one or more of supply (l) 64 through supply (N) 64 are used in order to accomplish the printing. Use of supply (l) 64 through supply (N) 64 by printing device 30B in printing a print job can result in the exhaustion of the one or more of supplies 64. A sensor (l) 66 through sensor (N) 66 can be used to respectively measure and/or sense the quality and/or quantity of supply (l) 64 through supply (N) 64. By way of example, and not by way of limitation, each supply 64 can be a printing supply, a printing media available to be printed on during the printing, a printing substance available for application to the printing media during the printing, toner available for application to the printing media during the printing, a laser printer drum, a laser printer developer, a laser printer fuser, a printing media transfer belt, staples for stapling the printing media during the printing, a storage volume that is available to store paper that has been printed on by the printing device, etc.

Memory tag 36 has a component memory 44, a logic component 46, and an electrical contact or antenna coil 48. The component memory 44 has at least one storage area that can include a replaceable component usage data 50 and an end-of-life status (i) 51. End-of-life status (i) 51 can be used to respectively store an estimated state of the end-of-life for supply (l) 64 through supply (N) 64. Memory tag 36, sensor(s) 66, and end-of-life status (i) 51 can individually or collectively operate in conjunction with an interrogating device, also known as an interrogator. An interrogator is a device that provides power to, reads from and/or writes to, the memory tag 36 and/or other aspects of replaceable component 32B. Examples of interrogators include a memory tag reader or scanner, a memory tag writing device which stores data on the memory tag 36, and the like. In the present example, the printing device 30B includes an interrogator 52. Interrogator 52 performs functions of a reader/writer, such as monitoring the contents of component memory 44, readings from one or more sensors 66, and replaceable component usage data 50.

The interrogator 52 can be electrically connected to contact 48 or the interrogator 52 can emits a radio frequency field that provides power to the memory tag 36 and/or other aspects of replaceable component 32B via the antenna coil 48. The memory tag 36 and/or other aspects of replaceable component 32B, therefore, do not require their own power supply. Communications between the interrogator 52 via antenna coil 48 and replaceable component 32B are transmitted and received via the radio frequency field and the antenna coil 48 utilizing standard RFID method and protocol, such as promulgated in ISO 14443 and ISO 15693. Therefore, physical contact for an electrically connection between replaceable component 32B and the printer 30 is not required for the printer 30 to communicate with the memory tag 36 as an RFID memory and/or other aspects of replaceable component 32B.

Each replaceable component 32B communicates with printing device 30B, which includes a printer memory 54. The printer memory 54 contains a print queue 59 and one or more storage areas that can include, but are not limited to, replaceable component usage data (k) 56 and end-of-life status (k) 57. Replaceable component usage data (k) 56 and end-of-life status (k) 57 store data that respectively correspond to replaceable component (l) 32B through replaceable component (j) 32B. Print queue 50 can be used to contain print data for each of one or more print jobs. Each print job is identified by a print job identifier (ID). Alternatively, or in addition thereto, a print queue 71 can also be stored is a memory 74 of a computer 67 that is in communication with printing device 30B. The contents of print queues 59, 71 are discussed more particularly with respect to FIG. 5.

The printing device 30B can have one or more sensors 68 that can be used to respectively monitor one or more supplies 66 of one or more replaceable components 32B. Sensors 68 can also include systems to measure the quantity and/or quality of print media that is available to be used to print on in a printing process. For instance, one such system can have a sheet counter 63 that includes a sheet feeder (not shown) that is used to feed each sheet of paper into a counting device (not shown) so as to count the number of available pieces of paper that can be printed on. Other such systems use sheet counter 63 to count the sheets of paper in an output bin (not shown) that forms a part of an output mechanism 65. A sheet feeder (not shown) is used to feed each sheet of paper into a counting device (not shown) so as to count the number of pieces of paper that have been printed on by output mechanism 65 and are stored in the output bin. From this count and a predetermined maximum capacity page count, a number of pages can be determined for which there is space available in the output bin. Another system can use an output bin that is monitored using a “full” sensor which does not count pages but simply indicates if there is room for yet another sheet to be fed into the output bin.

An input mechanism 60 can be associated with printing device 30B that can be a toggle switch or a button that can be depressed or otherwise activated by a user. A printer logic component 62 is included in printing device 30B to execute instructions for a printing operation. Output mechanism 65 can be a printing mechanism to print a print substance on print media (e.g. selectively placing printing ink and/or tone on print media such as paper). Output mechanism 65 can also include a display device for displaying a diagnostic and/or a prompt.

The sensor(s) 66 and/or sensor(s) 68 can be used to measure and/or sense the respective quantity and/or quality of one or more of supply (l) 64 through supply (N) 64 of one or more of respective replaceable component (l) 32B through replaceable component (j) 32B. As such, each sensor 66 and/or sensor 68 can be configured to measure and/or sense the occurrence of an end-of-life condition. By way of example of an end-of-life condition for a replaceable component, a sensor can measure the toner in a toner cartridge which measurement indicates an end-of-life condition for the toner in the toner cartridge, a zero page count realized by an Automatic Document Feeder (ADF) as to the number of pages that remain in a page supply for printing device 30B, a sensed and/or measured lack of a predetermined quality of a particular replaceable component 32B such that an end-of-life condition exists for the particular replaceable component 32B, a predetermined passage of time that a particular replaceable component 32B has been installed in printing device 30B that equates to a corresponding end-of-life condition, a measured and/or counted usage of a particular replaceable component 32B that exceeds a predetermined quantity that signifies a corresponding end-of-life condition for the particular replaceable component 32B, etc.

Printing device 30B is connected to computer 67, which can be any of servers 104A, 110 or workstation 108A seen in FIG. 1. Computer 67 includes memory 74 and a display monitor 70A. Display monitor 70A is an example of monitor 108C seen in FIG. 1. A graphical user interface (GUI) 72A is displayed on the display monitor 70A to provide visual information to the user. One or more counters 73 can be stored in memory tag 36, or in memory 74 of computer 67, to keep of count of the historical usage of one or more replaceable components 32B for the purpose of calculating the availability thereof for requested print jobs. A user can use computer 67 to schedule a print job on printing device 30B. A diagnostic with respect to an end-of-life condition of any replaceable component 32B can be displayed upon display monitor 70A. The diagnostic can be a characterization of the end-of-life condition or the results of a measurement and comparison calculation that output the unavailability of any replaceable component 32B to print a requested print job with the number of pages that can be printed using the one or more deficient replaceable components 32B. The display upon display monitor 70A can also include the number of pages in the entire requested print job as calculated by an aspect of one or more printer driver applications. A prompt can be displayed to the user on display monitor 70A that gives instructions as to how to input a demand to print out a number equal to or less than the number of pages in a requested print job that can be printed with available replaceable components 32B as related in the diagnostic.

The computer 67 and printing device 30B are connected via a network 76, such as the Internet, a local area network (LAN), a wide area network (WAN), or the like. Alternatively, computer 67 and printing device 30B can also be connected via a direct connection 78, such as by a parallel, serial, or USB port or other conventional connection scheme.

FIG. 5 is a block diagram of printing system 40 that shows pertinent components of a computer 67 in an implementation. Computer 67 seen in FIGS. 4-5, which can be workstation 108A seen in FIG. 1, is a computing device that includes one or more processors 202, memory 74, and one or more print queues 71, one or more counters 73 for counting aspects of one or more of supply (l) 64 through supply (n) 64 of corresponding one or more replaceable components 32B. Other fixed media and removable media memory devices 208 are optionally included in computer 67. Memory devices 68 and 208, which provide data storage mechanisms, can be read-only memory (ROM), random access memory (RAM), a hard drive, a floppy disk drive, a CD-ROM drive, and other conventional memory device, and can be used to store an output buffer that contains a rendered version of a document, a bitmap of an image of one or more pages or segments of a document, or other versions of the document as is appropriate for a particular outputting environment. Other storage uses include a print spool or print buffer.

The one or more processors 202 perform various instructions to control the operation of computer 67. These instructions can be in applications stored in memory devices 68 and/or 208, and include an operating system 260, one or more application programs 262, and one or more document processing applications 264 to process a document such as word processing programs, electronic mail programs, drawing programs, spreadsheet programs, slide show programs, and desk top publishing programs, where some applications can include a spooler component. Also included in the applications executed by the one or more processors 202 are one or more printer drivers 69. The one or more printer drivers 69 include one or more replaceable component availability modules 266. Each replaceable component availability module 266 contains instructions that, when executed by the one or more processors 202, calculate the availability of a corresponding replaceable component for an identified print job. The calculation can use measurements and/or counts that are made by one or more counters 73, or by one or more sensors 68, and/or by one or more sensors 66 of one or more corresponding replaceable components 32B. The calculation can also be made using the measurements and/or counts that are stored in replaceable component usage data 50, replaceable component usage data (k) 56, end-of-life status (i), and/or end-of-life status (k). After the foregoing calculations have been made and replaceable component availability is confirmed based upon the counts and/or measurements, each of one or more printer drivers 69, when executed by the one or more processors 202, outputs data to one or more printing devices 30B for further performance of a printing process.

Although FIG. 5 shows memory 74 with one or more application programs 262, one or more document processing applications 264, one or more printer drivers 69, one or more print queues, and one or more counter 73, these applications and storage components could also be stored on a server, such as one or more servers 104A and 110 seen in FIG. 1 and to which computer 67 can have access through interconnected network 76.

One or more peripheral output ports 210 provide a mechanism for computer 67 to communicate with other devices such as to the one or more printing devices 30B. The one or more print drivers 69, when executed, direct data to one or more peripheral output ports 210, which can be a wireless interface port 212, a network interface port 214, a serial port/parallel port 216, and/or a modem port 218. One or more graphic user input device(s) 72B can be used for inputting and outputting data, including a keyboard, a computer mouse, a pointing device, or other mechanism for inputting information to computer 67.

Computer 67 can include one or more rendering engines in the one or more application programs 262 and/or the one or more document processing applications 264 each of which can be executed by the one or more processors 202 so as to be capable of processing print data into a format understood by the respective one or more printing devices 30B so as to be output therefrom. Similarly, the servers 104A, 110 and the workstation 108A seen in FIG. 1 can include respective rendering engines that can process raw data into a language understood by any printer device connected on network 102. These rendering engines can be capable of rendering a document into a directly printable format by incorporating any fonts, templates, or other data required to render the document.

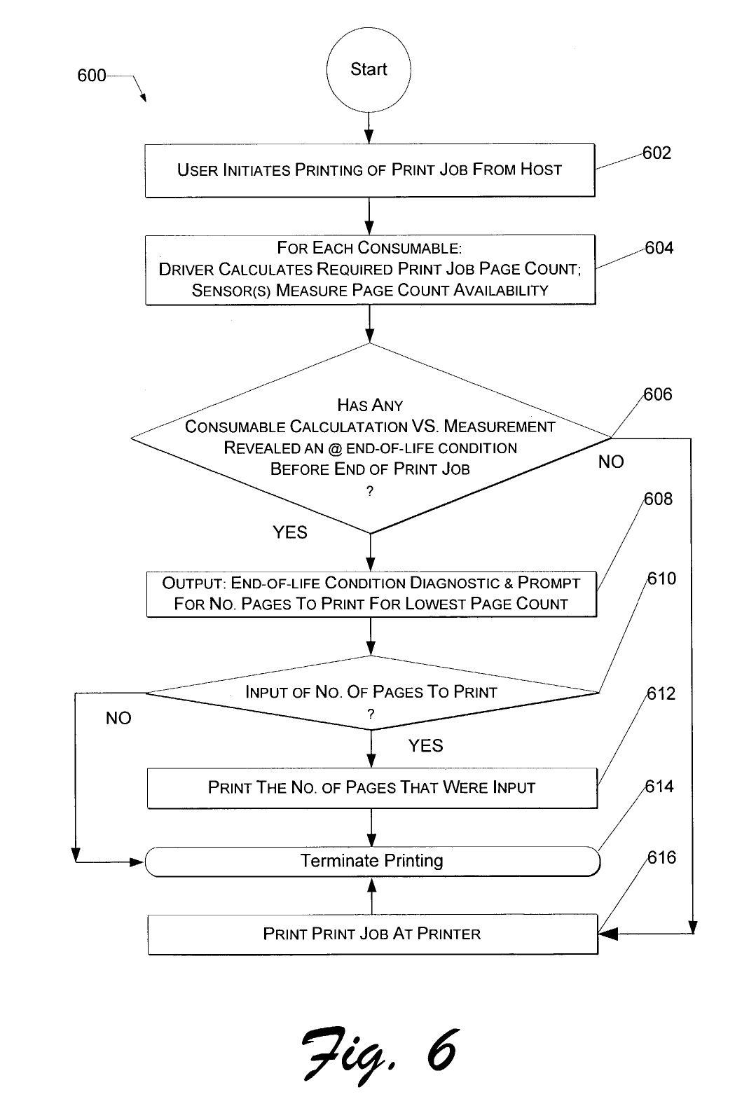

FIG. 6 depicts a process 600 in a flow diagram of a dynamic messaging process for communicating with a user, with particular reference to FIGS. 4-5 for illustrative purposes. At block 602, a user initiates a request to print a document by scheduling a print job that the user wishes to print at an identified printer. At block 604, one or more replaceable component availability modules 266 in respective one or more printer drivers 69 are executed by the one or more processors 202. Each replaceable component availability module 266 corresponds to one replaceable component 32B and calculates an amount and/or quality for the respective replaceable component 32B that is needed for the requested print job. Additionally, each replaceable component availability module 266 coordinates the measurement and/or count of an amount or a quality of the respective replaceable component 32B that is available to be used with respect to the requested print job. These measurements and/or counts can be obtained for use by the respective replaceable component availability modules 266 by input received from counters 73, from one or more sensors 68, and/or from one or more sensors 66 of one or more corresponding replaceable components 32B. These measurements and/or counts can also be obtained by retrieving data stored in replaceable component usage data 50, replaceable component usage data (k) 56, end-of-life status (i), and/or end-of-life status (k). Examples of data for these measurements and/or counts and comparison in which they are used are discussed below in reference to FIG. 8.

The results of these measurements and/or counts can be stored in memory 74, in other memory devices 208, in memory tag 36, and/or in memory associated with servers 104, 110. For instance, the result of a rasterization process that is calculated for a document of a requested print job can be stored to later use when the requested print job is subjected to further print job processing.

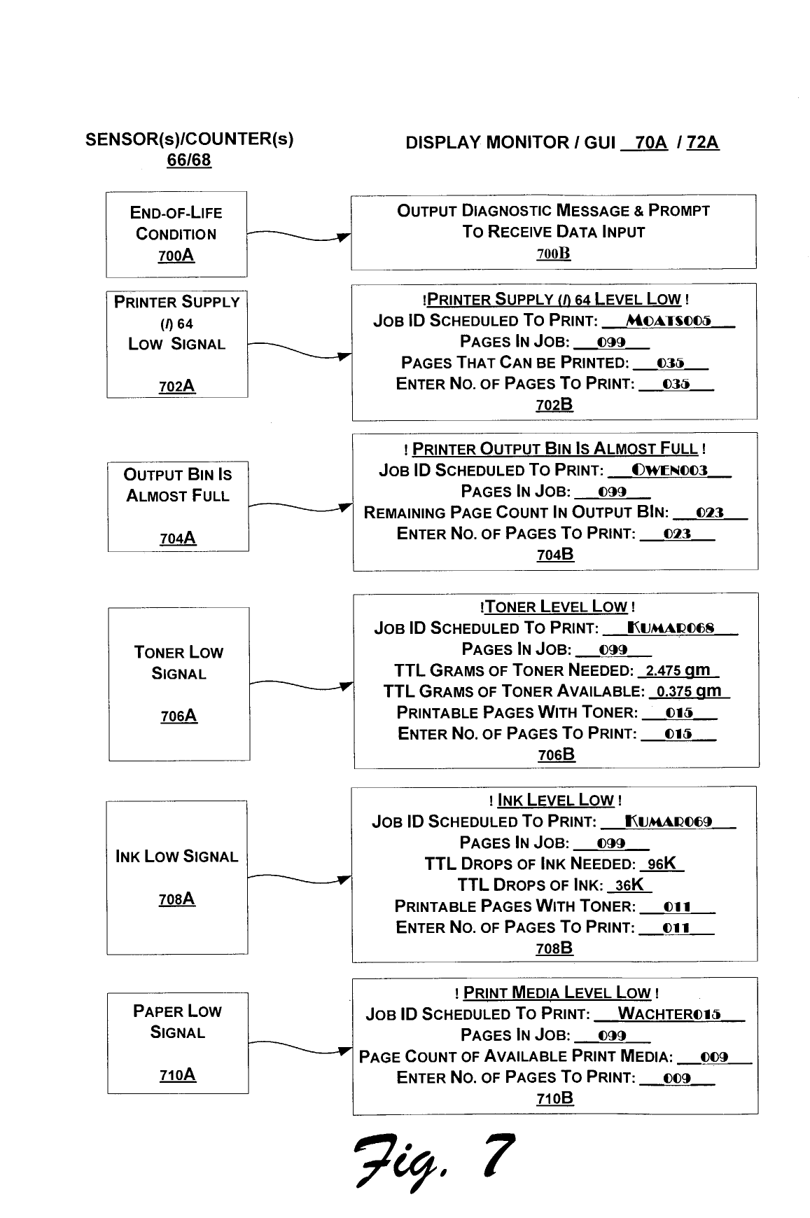

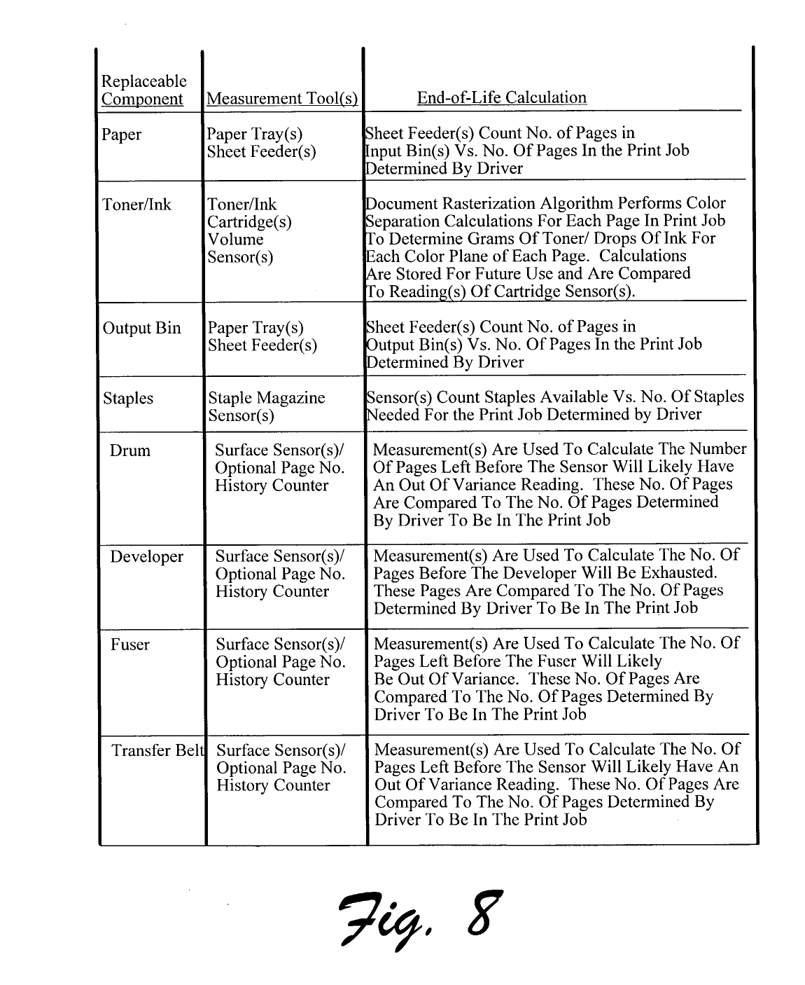

At block 606, the measurements and/or counts made at block 604 are subjected to comparison in a query. The query at block 606 determines whether each of the needed one or more replaceable components 32B have sufficient measured and/or counted availability to complete the demands of the requested print job at the identified printing device 30B. If so, then process 600 moves to block 616 where the requested print job is printed from one or more of print queues 59, 71 at printing device 32B, and after which process 600 terminates at block 614. If not, then process 600 moves to block 608 where a diagnostic is output upon display monitor 70A and/or output mechanism 65. The diagnostic informs the requesting user with a characterization as to the nature of the deficiency of one of more replaceable components 32B that are needed for the requested print job. The diagnostic can also inform the user as to the number of pages, or other printing delimiter, that the printing device 30B will be able to print given the aforesaid one or more deficiencies. A prompt can also be output with the diagnostic. Example diagnostics and prompts are discussed below in reference to FIG. 7. The prompt informs the user that, given the identified deficiency of one or more replaceable components, the user may input a number of pages to print at least some of the pages of the requested print job.

Where more than one replaceable component has been measured and/or counted and determined to be deficient in availability to print all of the pages of a requested print job, each such replaceable component may have a different number of pages that can be printed with their respective availabilities. In order to best use the requesting user's time and for efficiency of the printing process, the first diagnostic that should be output for review by the requesting user should be the least number of pages that can be printed among all of the one or more replaceable components have been found to be deficient in availability. In this way, a user need only respond once to the prompt to print at least some of the pages of the requested print job, which response will not exceed the calculated number of pages corresponding to the other deficient replaceable components.

At block 610, if process 600 determines that the prompt was responded to with input of a number from the user, process 600 moves to block 612. Otherwise, process 600 terminates at block 614. At block 612, the number that the user input in response to the prompt at block 610 is processed. The number should not be greater than the identified number of pages that the printing device 30B can be print before the calculated end-of-life condition is reached for the identified deficient one or more replaceable components. As such, the requested print job will be printed by the printing device 30B from one or more of print queues 59, 71, but just for the user-specified portion thereof. Accordingly, the resultant quality of the printing at printing device 30B will be ensured to a calculated certainty and process 600 will terminate at block 614. This certainty and quality can be obtained by accurately determining the requirements and corresponding availability of one or more replaceable components 32B that are required to print the requested print job at printing device 301B. Process 600 is repeated for each print job that is requested by the user to have printed at printing device 30B, as has been as described above.

The order in which a method is described with respect to process 600 is not intended to be construed as a limitation, and any number of the described method blocks can be combined in any order to implement the method. Furthermore, the method can be implemented in any suitable hardware, software, firmware, or combination thereof.

When process 600 is operated in an environment where the document processing device is a PC in communication with a printer, several parameters of operation can be implemented within the context of the rendering of the document in the PC and the rendering of the document in the printer. To process an entire print job, the printer may need the ability to interpret a language or format in which the document is stored. For example, if the document data is stored in a raw data format and the printer only understands the Printer Control Language (PCL) language, then the printer cannot process the document until some other device or process converts the raw data into a PCL format. Here, the PC can be this device or perform this process. However, if the document is already stored in a format that is understood by the printer, then the printer can process the document without assistance from an external device. If the printer can process the entire print job, then the document is printed by the printer. If the printer cannot process the entire print job, then the portions of the document (i.e., print job) that it cannot process are delegated to other processing devices.

By way of example of the output diagnostics referred to in the foregoing process 600, particular reference is made to FIG. 7. As discussed above, the quality and/or quantity of each of one or more replaceable components 32B can be measured and/or counted in order to calculate the availability thereof for a requested print job. These measurements can be taken, and monitoring thereof can be performed, by use of one or more sensor(s) 66 or/and sensor(s) 68, replaceable component usage data 50, replaceable component usage data (k) 56, end-of-life status (i) 51, end-of-life status (k) 57, counter 63, and/or counters 73. FIG. 7 shows various end-of-life conditions 700A and a corresponding output diagnostic message and prompt for receipt of data input 700B. Where more than one replaceable component is monitored for availability and more than one thereof are found to be lacking in sufficiency for the printing of an identified print job at an identified printing device, then each corresponding diagnostic and prompt can be displayed for review and response by a use. It is more expedient, however, to first output a diagnostic that corresponds to the least amount of printing for the least available replaceable component so that only one (1) response to a prompt need be made by a user. Alternatively, each of the several diagnostics and prompts seen in FIG. 7 can be output as each insufficiency of a replaceable component is determined for an identified print job at an identified printing device. If the user does not or cannot effect a replacement of the one or more deficient replaceable components to remedy the displays of insufficiency in the respective diagnostics, the user can reply to the prompt as discussed below.

End-of-Life condition 702A is a low signal for printer supply (i) 64 to signify that a corresponding supply 64 needed for printing device 30B is too low to print all of the ninety-nine (99) pages of a requested print job that has print job ID MOAT005. The low supply signal can be derived from a measured and/or counted quantification of the level of one or more supplies 64 in a corresponding replaceable component 32B. The diagnostic and prompt 702B corresponding to End-of-Life condition 702A shows the result of an algorithm that calculates the total amount of the supply that is needed for ninety-nine (99) pages of print job ID MOATS005. The results of the algorithm are compared to the quantification of the one or more supplies 64 to arrive at a determination that there is only enough of the one or more supplies 64 to print thirty-five (35) pages of print job ID MOATS005 on printing device 30B. Accordingly, a user responds to the prompt by inputting a request to print the first thirty-five (35) pages of the ninety-nine (99) pages of print job ID MOATS005, as seen in diagnostic and prompt 702B.

End-of-life condition 704A characterizes the replaceable component of an output bin that receives print media that has been printed on, in that the output bin is too full to receive all print media that is to be printed for a requested print job. End-of-life condition 704A can be realized by a system having sheet counter 63 that includes a sheet feeder (not shown) that is used to feed and count each sheet of paper that is in the output bin (not shown) that forms a part of an output mechanism 65. From this count and a predetermined maximum page count, a number of pages can be determined for which there is space available in the output bin. Corresponding to end-of-life condition 704A is diagnostic 704B that is output for review by the requesting user or the agent thereof. Diagnostic 704B discloses the near-full condition of the output bin, gives the job identifier (ID) in a print queue that is associated with the request print job, shows the total number of pages in the requested print job as derived by execution of a corresponding printer driver 69, lists the number of printed pages that can still be received in the output bin, and prompts the user to enter a number of pages that they want to have printed. Accordingly, the user responds to the prompt by inputting a request to print the first twenty-three (23) pages of the requested ninety-nine (99) page print job. Here the remaining storage available in the output bin was measured to be only twenty-three (23) pages.

End-of-Life condition 706A is a toner low signal that signifies that the level of toner that remains in toner cartridge 32A of laser printer 30A is too low to print all of the ninety-nine (99) pages of a requested print job that has print job ID Kumar068. The low toner signal can be derived from a measurement of the level of toner from as sensed by sensor 66 in toner cartridge 32A. The diagnostic and prompt 706B corresponding to End-of-Life condition 706A shows the result of a rasterization algorithm that calculates the grams of toner needed for the entire requested print job. The rasterization algorithm can be contained in a replacement component (i) availability module 266 for a toner cartridge 32A, where one or more color planes of each page in the document for the requested print job is figured into the calculation of grams of toner. The results of the rasterization process, which can be stored for future use, are compared to the measured number of grams of toner as sensed by sensor 66 in toner cartridge 32A to arrive at a determination that there is insufficient toner in the toner cartridge 32A to print all of the ninety-nine (99) pages in the entire requested document. As per an output of a diagnostic and prompt 706B, fifteen (15) pages can be printed at printing device 30B by exhausting the remaining 0.375 grams of toner in toner cartridge 32A, where the entire requested print job is listed as requiring 2.475 grams of toner. Accordingly, a user responds to the prompt by inputting a request to print the first fifteen (15) pages of the requested print out, as seen by the response input made by the user in diagnostic and prompt 706B.

End-of-Life condition 708A is an ink low signal that signifies that the level of ink that remains in an ink cartridge of an ink jet printer is too low to print all of the ninety-nine (99) pages of a requested print job that has print job ID Kumar069. The low ink signal can be derived from a measurement of the level of ink from as sensed by one or more sensors 66 in one or more supplies 64 of ink in a replaceable component 32B. The diagnostic and prompt 708B corresponding to End-of-Life condition 708A shows the result of a rasterization algorithm that calculates the drops of ink that are needed for the entire requested print job. The rasterization algorithm can be contained in a replacement component (i) availability module 266 for replaceable component 32B, where one or more color planes of each page in the document for the requested print job is figured into the calculation of drops of ink. The results of the rasterization process, which can be stored for future use, are compared to the measured number of drops of ink as sensed by one or more sensors 66 for one or more supplies 64 in one or more replaceable components 32B to arrive at a determination that there is insufficient ink to print all of the ninety-nine (99) pages in the entire requested print job Kumar069. As per an output of a diagnostic and prompt 708B, eleven (11) pages can be printed at printing device 30B by exhausting the remaining 36,000 drops of ink, where the entire requested print job is listed as requiring 96,000 drops of ink. Accordingly, a user responds to the prompt by inputting a request to print the first eleven (11) pages of the requested print out, as seen by the response input made by the user in diagnostic and prompt 708B.

End-of-Life condition 710A is a low paper signal that signifies that only the first nine (9) pages of the ninety-nine (99) pages of print job ID Wachter015 can printed on the available paper at printing device 30B, as indicated by corresponding diagnostic and prompt 710B. The low paper signal can be derived from a quantification of the level of paper, such as by a counter at printing device 30B that uses a sheet feeder to count the available paper and then compares this number to what is required for print job ID Wachter015 as determined by one or more printer drivers 69. Alternatively, the available paper can be quantified by weight and the weight then derived into a number of pages for comparison to the requirements of print job ID Wachter015. The user responds to the displayed by prompt by inputting a request to print the first nine (9) pages of the request print out, as seen in diagnostic and prompt 710B.

Other End-of-Life conditions are contemplated, such as those that are based upon a measurement of a quality of a replaceable component as determined by use of sensors and/or counters. Examples of such replaceable components include a laser printer developer, a laser printer fuser, and a laser printer drum. The sensors and/or counters can be used to count and/or measure the quality of a developer, drum, or fuser that are each installable in and removable from the laser printer. These laser printer replaceable components might also have corresponding memory that is configured to store replaceable component usage data received from a reader/writer located in the laser printer. The reader/writer can monitor the replaceable component usage data. The reader/writer can receive input from the sensors and/or counters to predetermine whether, and how many more pages could be printed before, there is an end-of-life condition. The memory can be an RFID memory or a direct contact identification memory. Another aspect of these laser printer replaceable components can be a page count received from a page counter in the reader/writer that maintains the historical data of a page count which is the number of pages printed using the fuser, developer, and/or drum. Once this page count measurement is compared to a predetermined maximum page count, these replaceable components can be deemed to be at an end-of-life condition. Moreover, the page count measurement can be used in combination with data received from one or more sensors used to monitor the quality characteristic of the fuser, developer, and/or drum so as to calculate the respective availabilities thereof for future and current printing operations. From these respective availabilities, for example, it might then be determined that only twenty-three (23) pages of a ninety-nine (99) pages of print job can be printed on a user-designated printing device. A corresponding diagnostic might be output accordingly, as well as a prompt to display a query to a user as to whether all or some of the twenty-three (23) pages should be printed at the user-designated printing device. The user can then response to the prompt by inputting a request to print all the first twenty-three (23) pages as was suggested in the prompt.

End-of-life conditions 700A and corresponding output diagnostic messages and prompts for receipt of data input 700B can be stored in a message lookup table (not shown) contained in any of memory 74, memory tag 36, and/or in printer memory 54. Those of ordinary skill in the relevant arts, using the present patent as a guide, will understand that the calculations for an end-of-life condition of a replaceable component for a printing device can be made by use of known techniques and known quality and quantity measurement capabilities. Accordingly, the scope of the implementations is intended to include those techniques and measuring capabilities now known and yet to be developed.

FIG. 8, by way of example, presents a table of replaceable components for a color laser printer. Replaceable components are seen in the first column. The second column contains a list of historical data and/or sensors that can be used to determine the quality and/or the quantity of the replaceable component in the same row, and an algorithm for calculations related to a determination of the availability of the replaceable component in the same row for printing an entire requested print job. The text of the table entries respectively explains the replaceable components, the historical data and sensor measurements, and the end-of-life calculations. Different ways exist for one or more of the historical data and/or sensor(s) to be used retrieve and coordinate the display diagnostics and prompts related to the end-of-life calculations for respective replaceable components, such as by the execution of instructions on one or more logic components 46, on one or more printer logic components 62, and/or on computer 66. Those of ordinary skill in the relevant arts can use this patent as a guide in implementation of any such way.

The printed document that is printed by a printing device in various implementations can have many forms. For instance, the document can be a letter containing text that is being edited by a word processing program, an electronic mail (e-mail) message that is being created by an e-mail program, a drawing that is created by the user by operating a drawing program, a spreadsheet that the user is constructing by operating a spreadsheet program, or a poster that is being designed by a user by operating a desktop publishing program. Other types of documents are also contemplated for use in other implementations.

In various implementations, the printing device can be a simple dot matrix printer or a complex printer such as a digital press or a network printer. Complex printers can have capabilities that include high quality photo reproduction, multi-section reports with tabs, in-line mixed material insertion such as insertion of full-color preprinted copies and digital color-page insertion. Other complex printer capabilities include printing on substrates of varied composition, such as embossed, heavy-weight, multi-weight, and cover paper stock, as well as carbonless paper, blue prints, clear or colored transparency printing, and other specialty stock including preprinted offset color covers. Still other complex printer capabilities includes binding, collating, folding, stacking, stapling, stitching such as saddle stitching, edge-trimming, paginating for multi-language, and inline pagination and annotation. Still another printer is a multifunction peripheral (MFP), sometimes referred to as an “All-In-One”, which combines two or more peripheral devices into a single device, such as printing, scanning, copying, and facsimile transmission. The printer can be a Graphical Display Interface (GDI) printer or a printer interpreting a page description language.

In other implementations, the document processing application executes on a logic component of the document processing device to form a bitmap image of a document that is communicated to the printing device through the interconnected network. In still another implementation, the document processing application is included in a word processing application. In yet another implementation, the document processing application includes a spooler for spooling print jobs that are to be communicated to the printing device through the interconnected network or through a hardware port on a PC.

Thus, although some embodiments of the various methods, printing devices, and toner cartridges of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the scope of the invention as set forth and defined by the following claims.

What is claimed is:

1. A method comprising:
receiving a designation of a print job to be printed at a printing device;
calculating a requirement of a replaceable component that is required to print the designated print job at the printing device;
measuring the replaceable component at the printing device to determine an availability of the replaceable component at the printing device;
transmitting the designated print job for printing at the printing device when the availability is not less than the requirement for the replaceable component; and
outputting a diagnostic without transmitting the designated print job for printing at the printing device when the availability is less than the requirement.

2. The method as defined in claim 1, wherein the outputting a diagnostic further comprises outputting an identifier (ID) of the print job and an identification of the replaceable component.

3. The method as defined in claim 1, wherein the outputting a diagnostic further comprises outputting a characterization of the difference between the availability and the requirement.

4. The method as defined in claim 1, wherein the method further comprises, after the outputting a diagnostic:
receiving input of a quantity not greater than the availability of the replaceable component at the printing device; and
transmitting the designated print job for printing at the printing device.

5. The method as defined in claim 4, further comprising transmitting the received input quantity to the printing device for the printing of a portion of the print job that uses an amount of the replacement component corresponding to the received input quantity.

6. The method as defined in claim 1, wherein:
the requirement is expressed in units of pages; and
the outputting a diagnostic further comprises outputting the number of pages of the requirement.

7. The method as defined in claim 6, wherein the method further comprises, after the outputting a diagnostic:
receiving input of a number of pages not greater than the number of pages of the requirement; and
transmitting the designated print job and the received input number of pages to the printing device for the printing of the received input number of pages of the print job.

8. The method as defined in claim 1, wherein the replaceable component is selected from the group consisting of:
printing media available to be printed on during the printing;
printing substance for printing on the printing media;
toner available for application to the printing media;
a laser printer drum;
a laser printer developer;
a laser printer fuser;
a printing media transfer belt;
an ink cartridge for an ink jet printer;
staples for stapling the printing media; and
an output volume available for storage of the printing media that is to be printed on.

9. The method as defined in claim 1, wherein the measuring the replaceable component comprises:
feeding each sheet of paper in an input bin with a sheet feeder while counting each sheet to measure the number of pieces of paper in the input bin as the availability of the replaceable component at the printing device.

10. The method as defined in claim 1, wherein the measuring the replaceable component comprises:
feeding each sheet of paper in an output bin with a sheet feeder while counting each sheet; and
subtracting the number of the counted sheets of paper from a maximum number of pieces of paper for storage in the output bin to determine the number of pieces of paper that can still be stored in the output bin as the availability of the replaceable component at the printing device.

11. The method as defined in claim 1, wherein the measuring the replaceable component comprises:
weighing an amount of printing substance available for printing on a printing media; and
deriving the availability of the replaceable component at the printing device as a function of the weight of the amount of printing substance available for printing on a printing media.

12. The method as defined in claim 1, wherein the measuring the replaceable component comprises:
sensing one or more qualitative characteristic of the replaceable component; and
calculating a number of pages that can be printed at the printing device as a function of the sensed one or more qualitative characteristics, wherein the calculated number of pages is the availability of the replaceable component at the printing device.

13. The method as defined in claim 12, wherein the replaceable component is selected from the group consisting of:
an ink cartridge for an ink jet printer;
a laser printer drum;
a laser printer developer;
a laser printer fuser; and
a printing media transfer belt.

14. The method as defined in claim 1, wherein the calculating a requirement of a replaceable component that is required to print the designated print job at the printing device comprises:
performing a rasterizing algorithm for each color plane on each page of the print job to derive one or more of said requirement, wherein each said requirement corresponds to a printing substance that is required to be printed on a print medium in order to print the print job on the printing device.

15. The method as defined in claim 1, wherein the calculating a requirement of a replaceable component that is required to print the designated print job at the printing device is performed by one or more printer driver applications that are designed for the printing device.

16. A computer-readable medium having computer-executable instructions which, when executed on a processor, direct a computer having a capability to communicate with a printing device to perform a method comprising:
receiving a designation of a print job to be printed at the printing device;
calculating a requirement quantity of a printing substance that is required to print the designated print job at the printing device on print media, wherein:
the printing substance is selected from the group consisting of toner and ink;
the requirement quantity is calculated by a rasterizing algorithm for each color plane on each page of the print job;
the requirement quantity of the printing substance is selected from the group consisting of weight of toner and drops of ink; and
the printing media is selected from the group consisting of paper and synthetic substrate material;
measuring an availability quantity of the printing substance at the printing device, the availability quantity being selected from the group consisting of weight of toner and drops of ink;
transmitting the designated print job for printing at the printing device when the availability quantity is not less than the requirement quantity; and
outputting a diagnostic without transmitting the designated print job for printing at the printing device when the availability quantity is less than the requirement quantity.

17. The computer-readable medium as defined in claim 16, wherein the outputting a diagnostic further comprises outputting an identifier (ID) of the print job and an identification of the printing substance.

18. The computer-readable medium as defined in claim 16, wherein the outputting a diagnostic further comprises outputting a characterization of the difference between the availability quantity and the requirement quantity.

19. The computer-readable medium as defined in claim 16, wherein the method further comprises, after the outputting a diagnostic:
receiving an input quantity corresponding to a quantity that is not greater than the availability quantity; and
transmitting the designated print job for printing at the printing device along with the quantity that corresponds to the input quantity.

20. The computer-readable medium as defined in claim 16, wherein the method further comprises, after the outputting a diagnostic:
receiving input of a quantity not greater than the availability quantity of the printing substance; and
transmitting the designated print job for printing at the printing device.

21. The computer-readable medium as defined in claim 20, wherein the transmitting the designated print job for printing at the printing device further comprises transmitting the received input quantity to the printing device for the printing of a portion of the print job that uses an amount of the printing substance corresponding to the received input quantity.

22. The computer-readable medium as defined in claim 16, wherein:
the requirement quantity is expressed in units of pages; and
the outputting a diagnostic further comprises outputting the number of pages of the requirement quantity.

23. The computer-readable medium as defined in claim 22, wherein the method further comprises, after the outputting a diagnostic:
receiving input of a number of pages not greater than the number of pages of the requirement quantity; and
transmitting the designated print job and the received input number of pages to the printing device for the printing of the received input number of pages of the print job.

24. The computer-readable medium as defined in claim 16, wherein the outputting a diagnostic further comprises outputting a number of pages corresponding to the requirement quantity of the printing substance.

25. The computer-readable medium as defined in claim 24, wherein the method further comprises, after the outputting a diagnostic:
receiving input of a number of pages not greater than the number of pages corresponding to the availability quantity of the printing substance; and
transmitting the designated print job for printing at the printing device along with the input number of pages.

26. A computer-readable medium having computer-executable instructions which, when executed on a processor, direct a computer having a capability to communicate with a printing device to perform a method comprising:
receiving a designation of a print job to be printed at the printing device from a document processing application executing on the computer;
calculating a required amount that is needed to print the designated print job at the printing device for each of one or more replaceable components used by the printing device;
measuring an available amount at the printing device for each of the one or more replaceable components;
printing the designated print job at the printing device when the available amount is not less than the calculated amount for each of the one of the one or more replaceable components; and
outputting a diagnostic without printing the designated print job at the printing device when the available amount less than the calculated amount for at least one of the one or more replaceable components.

27. The computer-readable medium as defined in claim 26, wherein the outputting a diagnostic further comprises outputting an identifier (ID) of the print job and an identification of the at least one of the one or more replaceable components.

28. The computer-readable medium as defined in claim 26, wherein the outputting a diagnostic further comprises outputting a characterization of the difference between the available amount and the calculated amount for the at least one of the one or more replaceable components.

29. The computer-readable medium as defined in claim 26, wherein the method further comprises, after the outputting a diagnostic:
receiving input of a quantity not greater than a quantity corresponding to the available amount of the at least one of the one or more replaceable component; and
transmitting the designated print job for printing at the printing device.

30. The computer-readable medium as defined in claim 29, wherein the method further comprises transmitting the received input quantity to the printing device for the printing of a portion of the print job that uses an amount of the at least one of the one or more replaceable component corresponding to the received input quantity.

31. The computer-readable medium as defined in claim 26, wherein:
the required amount is expressed in units of pages; and
the outputting a diagnostic further comprises outputting the number of pages of the required amount for the at least one of the one or more replaceable component.

32. The computer-readable medium as defined in claim 31, wherein the method further comprises, after the outputting a diagnostic:
receiving input of a number of pages not greater than the number of pages of the requirement amount of the at least one of the one or more replaceable component; and
transmitting the designated print job and the received input number of pages to the printing device for the printing of the received input number of pages of the print job.

33. The computer-readable medium as defined in claim 26, wherein each said replaceable component is selected from the group consisting of:
printing media available to be printed on during the printing;
printing substance for printing on the printing media;
an ink cartridge for an ink jet printer;
toner available for application to the printing media;
a laser printer drum;
a laser printer developer;
a laser printer fuser;
a printing media transfer belt;
staples for stapling the printing media; and
an output volume available for storage of the printing media that is to be printed on

34. A host computing system comprising:
means for creating print data for a print job to be output by a printing device;
means for calculating a requirement of a replaceable component that is required to print the designated print job at the printing device;
means for measuring an availability of the replaceable component at the printing device;
means for transmitting the designated print job for printing at the printing device when the availability is not less than the requirement for the replaceable component; and
means for outputting a diagnostic without transmitting the designated print job for printing at the printing device when the availability is less than the requirement.

35. The host computing system as defined in claim 34, wherein each said means is created by a printer driver application executed by the host computing system.

36. The host computing system as defined in claim 34, wherein the means for outputting a diagnostic further comprises means for outputting an identifier (ID) of the print job and an identification of the replaceable component.

37. The host computing system as defined in claim 34, wherein the means for outputting a diagnostic further comprises means for outputting a characterization of the difference between the availability and the requirement.

38. The host computing system as defined in claim 34, wherein the host computing system further comprises means, after the outputting a diagnostic, for:
receiving input of a quantity not greater than the availability of the replaceable component at the printing device; and
transmitting the designated print job for printing at the printing device.

39. The host computing system as defined in claim 38, further comprising means for transmitting the received input quantity to the printing device for the printing of a portion of the print job that uses an amount of the replacement component corresponding to the received input quantity.

40. The host computing system as defined in claim 34, wherein:
the requirement is expressed in units of pages; and
the means for outputting a diagnostic further comprises means for outputting the number of pages of the requirement.

41. The host computing system as defined in claim 40, further comprising means, after the outputting a diagnostic for:
receiving input of a number of pages not greater than the number of pages of the requirement; and
transmitting the designated print job and the received input number of pages to the printing device for the printing of the received input number of pages of the print job.

42. The host computing system as defined in claim 34, wherein the replaceable component is selected from the group consisting of:
printing media available to be printed on during the printing;
printing substance for printing on the printing media;
toner available for application to the printing media;
an ink cartridge for an ink jet printer;
a laser printer drum;
a laser printer developer;
a laser printer fuser;
a printing media transfer belt;
staples for stapling the printing media; and
an output volume available for storage of the printing media that is to be printed on.
